(19) United States
(12) Patent Application Publication
(10) Pub. No.: US 2026/0360190 A1
(43) Pub. Date: Nov. 12, 2026

(54) VEHICLE DATA COLLECTION SYSTEM, IN-VEHICLE APPARATUS, SERVER, NON-TRANSITORY COMPUTER-READABLE STORAGE MEDIUM STORING A COMPUTER PROGRAM, AND VEHICLE DATA COLLECTION METHOD

(71) Applicant: SUMITOMO ELECTRIC INDUSTRIES, LTD., Osaka-shi, Osaka (JP)

(72) Inventors: Tomoyuki KITADA, Osaka-shi, Osaka (JP); Hidenobu NAKAMURA, Osaka-shi, Osaka (JP); Kengo AIHARA, Osaka-shi, Osaka (JP)

(73) Assignee: SUMITOMO ELECTRIC INDUSTRIES, LTD., Osaka-shi, Osaka (JP)

(21) Appl. No.: 19/125,781

(22) PCT Filed: Sep. 22, 2023
(86) PCT No.: PCT/JP2023/034391

§ 371 Date: Apr. 30, 2025

(30) Foreign Application Priority Data
Nov. 2, 2022 (JP) 2022-175951

(51) Int. Cl. G07C 5/00

(52) U.S. Cl. CPC G07C 5/008

(57) ABSTRACT

A vehicle data collection system equipped with an in-vehicle device installed in a vehicle and a server for collecting data from the in-vehicle device, wherein: the in-vehicle device is equipped with a data collection unit for collecting vehicle data, which is data pertaining to the vehicle, a data conversion unit for converting the collected vehicle data into formatted data of a version which corresponds to the vehicle data type, and writing said version onto the formatted data, and a data transmission unit for transmitting the formatted data onto which said version has been written to the server; and the server is equipped with a data-receiving unit for receiving the formatted data, and a data restoration unit for restoring the vehicle data from the formatted data on the basis of the version indicated by the formatted data.

### TECHNICAL FIELD

The present disclosure relates to a vehicle data collection system, an in-vehicle apparatus, a server, a computer program, and a vehicle data collection method. This application claims priority to Japanese Patent Application No. 2022-175951 filed on Nov. 2, 2022, and the entire contents of the Japanese patent application are incorporated herein by reference.

### BACKGROUND ART

Conventionally, a tracking inventory management system that grasps and records position information of a vehicle or a driver in real time has been developed (for example, see Non-patent literature 1).

### CITATION LIST

### Non Patent Literature

Non-patent literature 1: “What is tracking inventory management? Learn about the benefits and key points of a tracking inventory management system”, [online], Jul. 13, 2020, BIPROGY Group, Ltd., [search on August 26, 2022], Internet <URL: https://dr.biprogy.com/column/2020/0713.html>

### SUMMARY OF INVENTION

A vehicle data collection system according to an aspect of the present disclosure includes an in-vehicle apparatus configured to be mounted on a vehicle, and a server configured to collect data from the in-vehicle apparatus. The in-vehicle apparatus includes a data collection unit configured to collect vehicle data, the vehicle data being data related to the vehicle, a data conversion unit configured to convert the collected vehicle data into format data of a version corresponding to a type of the vehicle data and write the version to the format data, and a data transmission unit configured to transmit the format data with the version written thereto to the server. The server includes a data reception unit configured to receive the format data, and a data restoration unit configured to restore the vehicle data from the format data, based on the version indicated in the format data.

The present invention can be achieved not only as a vehicle data collection system including such characteristic processing units, but also as a vehicle data collection method including such characteristic processing as steps, and as a computer program for causing a computer to execute such steps. Further, it is possible to provide a semiconductor integrated circuit that becomes as part or all of a vehicle data collection system.

### BRIEF DESCRIPTION OF THE DRAWINGS

FIG. 1 is a diagram showing an example of the overall configuration of an operation management system according to an embodiment of the present disclosure.

FIG. 2 is a block diagram showing an example of the configuration of an in-vehicle apparatus.

FIG. 3 is a diagram showing an example of the data structure of format data.

FIG. 4 is a block diagram showing an example of the configuration of a server.

FIG. 5 is a diagram showing an example of external data included in format data.

FIG. 6 is a diagram for explaining the conversion process of vehicle data.

FIG. 7 is a diagram for explaining a conversion process of vehicle data.

FIG. 8 is a diagram showing an example of vehicle data restored by converting format data.

FIG. 9 is a block diagram showing an example of the configuration of an administrator terminal.

FIG. 10 is a diagram showing an example of screen information displayed on the display unit.

FIG. 11 is a diagram showing an example of screen information displayed on the display unit.

FIG. 12 is a diagram showing an example of screen information displayed on the display unit.

FIG. 13 is a diagram showing an example of screen information displayed on the display unit.

FIG. 14 is a diagram showing an example of screen information displayed on the display unit.

FIG. 15 is a sequence diagram showing an example of a processing procedure of the operation management system.

FIG. 16 is a sequence diagram showing an example of a processing procedure of the operation management system.

FIG. 17 is a sequence diagram showing an example of a processing procedure of the operation management system.

FIG. 18 is a sequence diagram showing an example of a processing procedure by the operation management system.

FIG. 19 is a sequence diagram showing an example of a processing procedure by the operation management system.

### DETAILED DESCRIPTION

### Problems to be Solved by Present Disclosure

For example, the types of sensors mounted on each vehicle is different between the package delivery company of and the car sharing company. Further, even in the case of delivery vehicles managed by the same delivery company, the types of sensors mounted may vary depending on the types of packages. For example, a delivery vehicle for delivering frozen and refrigerated products may be mounted with a temperature sensor, but a delivery vehicle for delivering packages that does not require temperature management may not be mounted with a temperature sensor.

Thus, there is a problem that the process of determining the vehicle data collected from each vehicle is complicated for the server that performs the tracking inventory management.

The present disclosure has been made in view of the above circumstances, and an object of the present disclosure is to provide a vehicle data collection system, an in-vehicle apparatus, a server, a computer program, and a vehicle data collection method that can efficiently collect vehicle data from a plurality of vehicles having different types and different numbers of sensors mounted thereon.

### Advantageous Effects of Present Disclosure

According to the present disclosure, vehicle data can be efficiently collected from a plurality of vehicles having different numbers and types of sensors mounted thereon.

### Summary of Embodiments of Present Disclosure

First, an overview of embodiments of the present disclosure will be listed and described.

(1) A vehicle data collection system according to an embodiment of the present disclosure includes an in-vehicle apparatus configured to be mounted on a vehicle, and a server configured to collect data from the in-vehicle apparatus. The in-vehicle apparatus includes a data collection unit configured to collect vehicle data, the vehicle data being data related to the vehicle, a data conversion unit configured to convert the collected vehicle data into format data of a version corresponding to a type of the vehicle data and write the version to the format data, and a data transmission unit configured to transmit the format data with the version written thereto to the server. The server includes a data reception unit configured to receive the format data, and a data restoration unit configured to restore the vehicle data from the format data, based on the version indicated in the format data.

According to this, the version is determined according to the type of the vehicle data, and the vehicle data is converted into format data of the version corresponding to the type of the vehicle data. In other words, it is converted to format data that is data in a data format corresponds to the version. Then, the format data is transmitted from the in-vehicle apparatus to the server. Thus, the server can use the version as a clue to restore the format data to vehicle data using a conversion method appropriate for each version. Thus, the server can efficiently collect vehicle data from a plurality of vehicles having different numbers and types of sensors mounted thereon.

(2) In the above (1), the server may further include a display control unit configured to display the vehicle data restored by the data restoration unit.

Thus, vehicle data collected from a plurality of vehicles having different numbers and types of sensors mounted thereon can be displayed on the screen.

(3) In the above (2), the server may further include a display item information acquisition unit configured to acquire display item information indicating a type of the vehicle data to be displayed, and a vehicle data selection unit configured to select the vehicle data of the type indicated by the display item information from among pieces of the vehicle data having been restored, and the display control unit may be configured to display the vehicle data selected by the vehicle data selection unit.

Thus, the vehicle data of the type desired by the administrator can be displayed from the vehicle data collected by the server.

(4) In the above (2) or (3), the data collection unit may be configured to collect a position of the vehicle as the vehicle data, the data reception unit may be configured to further receive notification data notified by an occupant of the vehicle, and the display control unit may be configured to further display the notification data received by the data reception unit in association with a position of the vehicle on a map, based on the vehicle data.

For example, when the occupant notifies the rest area, the rest area is displayed on the map. This makes it possible to notify the rest area to other occupants who have viewed the display. In this way, notification data can be supplied among a plurality of occupants and users.

(5) In any one of the above (2) to (4), the data collection unit may be configured to collect, as the vehicle data, data related to at least one of an amount of carbon dioxide in the vehicle, an amount of odor in the vehicle, and a breath alcohol concentration of an occupant of the vehicle, and a position of the vehicle, and the display control unit may be configured to display, based on the vehicle data, data restored by the data restoration unit and related to at least one of the amount of carbon dioxide in the vehicle, the amount of odor in the vehicle, and a breath alcohol concentration of the occupant of the vehicle in association with a position of the vehicle on a map.

Thus, it is possible to identify the vehicle and the position of the vehicle in which the abnormality of the amount of carbon dioxide in the vehicle, the amount of odor in the vehicle, or the breath alcohol concentration of the occupant occurs.

(6) In any one of the above (1) to (5), a vehicle data collection system may further include a conversion rule information registration unit configured to register conversion rule information in the in-vehicle apparatus and the server, the conversion rule information indicating the version and a conversion method corresponding to the version. The conversion method may include a method of conversion between the vehicle data and the format data.

Thus, even when a new sensor is added to the vehicle and vehicle data collected by the in-vehicle apparatus is added, the in-vehicle apparatus and the server can perform data conversion between vehicle data and format data according to the new conversion rule information.

(7) An in-vehicle apparatus according to another embodiment of the present disclosure includes a data collection unit configured to collect vehicle data, the vehicle data being data related to a vehicle, a data conversion unit configured to convert the collected vehicle data into format data of a version corresponding to a type of the vehicle data and write the version to the format data, and a data transmission unit configured to transmit the format data with the version written thereto to a server.

This configuration is similar to the configuration of the in-vehicle apparatus provided in the vehicle data collection system described above. Thus, the same operation and effect as the vehicle data collection system described above can be achieved.

(8) A server according to another embodiment of the present disclosure includes a data reception unit configured to receive format data obtained by converting vehicle data in accordance with a version corresponding to a type of the vehicle data, the vehicle data being data related to a vehicle, the format data having the version written thereto, and a data restoration unit configured to restore the vehicle data from the format data, based on the version indicated in the format data.

This configuration is similar to the configuration of the server provided in the vehicle data collection system described above. Thus, the same operation and effect as the vehicle data collection system described above can be achieved.

(9) A computer program according to another embodiment of the present disclosure causes a computer to function as a data collection unit configured to collect vehicle data, the vehicle data being data related to a vehicle, a data conversion unit configured to convert the collected vehicle data into format data of a version corresponding to a type of the vehicle data and write the version to the format data; and a data transmission unit configured to transmit the format data with the version written thereto to a server.

According to this configuration, the computer can be caused to function as the in-vehicle apparatus included in the vehicle data collection system. Thus, the same operation and effect as the vehicle data collection system described above can be achieved.

(10) A computer program according to another embodiment of the present disclosure causes a computer to function as a data reception unit configured to receive format data obtained by converting vehicle data in accordance with a version corresponding to a type of the vehicle data, the vehicle data being data related to a vehicle, the format data having the version written thereto, and a data restoration unit configured to restore the vehicle data from the format data, based on the version indicated in the format data.

According to this configuration, the computer can be caused to function as a server included in the vehicle data collection system. Thus, the same operation and effect as the vehicle data collection system described above can be achieved.

(11) A vehicle data collection method according to another embodiment of the present disclosure includes by an in-vehicle apparatus mounted on a vehicle, collecting vehicle data, the vehicle data being data related to the vehicle, by the in-vehicle apparatus, converting the collected vehicle data into format data of a version corresponding to a type of the vehicle data and writing the version to the format data, by the in-vehicle apparatus, transmitting the format data with the version written thereto to a server, by the server, receiving the format data, and by the server, restoring the vehicle data from the format data, based on the version indicated in the format data.

This configuration includes characteristic processing in the above-described vehicle data collection system as steps. Thus, according to this configuration, the same operation and effect as the vehicle data collection system described above can be achieved.

### Details of Embodiments of Present Disclosure

Hereinafter, embodiments of the present disclosure will be described with reference to the drawings. It is noted that, the embodiments described below are all specific examples of the present disclosure. Numerical values, shapes, materials, structural elements, the arrangement and connection of the structural elements, steps, the order of the steps, and the like shown in the following embodiments are mere examples, and do not limit the present disclosure. Further, among the constituent elements in the following embodiments, constituent elements not recited in the independent claims are constituent elements that can be added as needed. Furthermore, each drawing is a schematic view and is not necessarily illustrated strictly.

The same components are denoted by the same reference numerals. The functions and names of these components are the same, and thus the description thereof will be omitted as appropriate.

### Overall Configuration of Operation Management System

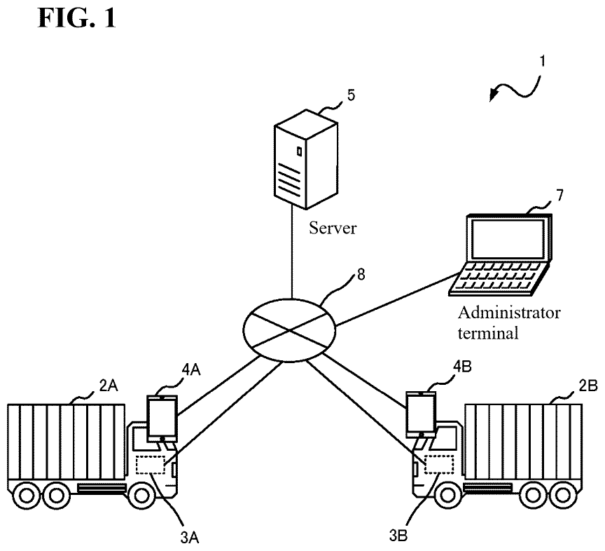

FIG. 1 is a diagram showing an example of an overall configuration of an operation management system according to an embodiment of the present disclosure.

An operation management system 1 includes an in-vehicle apparatus 3A and an in-vehicle apparatus 3B, a smartphone 4A and a smartphone 4B, a server 5, and an administrator terminal 7. In-vehicle apparatus 3A and in-vehicle apparatus 3B are mounted on a vehicle 2A and a vehicle 2B, respectively. Smartphone 4A and smartphone 4B are carried by occupants such as drivers of vehicle 2A and vehicle 2B, respectively. Smartphones 4A and 4B are examples of terminal devices carried by occupants. Thus, a terminal device such as a tablet terminal or a notebook computer that can be carried by an occupant can be used instead of smartphones 4A and 4B.

In-vehicle apparatuses 3A and 3B and smartphones 4A and 4B are wirelessly connected to a network 8. Server 5 and administrator terminal 7 are connected to network 8 in a wireless or wired manner.

Vehicles 2A and 2B are collectively referred to as a vehicle 2, in-vehicle apparatuses 3A and 3B are collectively referred to as an in-vehicle apparatus 3, and smartphones 4A and 4B are collectively referred to as a smartphone 4. In FIG. 1, the number of each of vehicle 2, in-vehicle apparatus 3, and smartphone 4 is two, but may be three or more.

In-vehicle apparatus 3 collects vehicle data, which is data related to vehicle 2, and transmits the collected vehicle data to server 5 via network 8. The vehicle data includes measurement results by various sensors installed in vehicle 2. The vehicle data will be described in detail later.

Smartphone 4 accepts input of notification data notified by the occupant of vehicle 2, and transmits the notification data to server 5 via network 8. The notification data includes data useful for the operation of vehicle 2. The notification data includes, for example, a rest area of vehicle 2, the place of traffic regulation by the police, the place of traffic accident, and the place where there was some kind of complaint. For example, a number is associated with each notification data in advance, and when the occupant operates smartphone 4 to input the number, smartphone 4 transmits the notification data corresponding to the number to server 5.

Server 5 receives the vehicle data and the notification data from in-vehicle apparatus 3 and smartphone 4, respectively, via network 8, and displays the received vehicle data and notification data on the display of administrator terminal 7.

Administrator terminal 7 is a terminal device used by the administrator of vehicle 2, and issues an instruction for displaying a screen to server 5. Administrator terminal 7 receives the screen information for display from server 5 via network 8, and displays the screen information on the display of administrator terminal 7.

### Configuration of In-Vehicle Apparatus 3

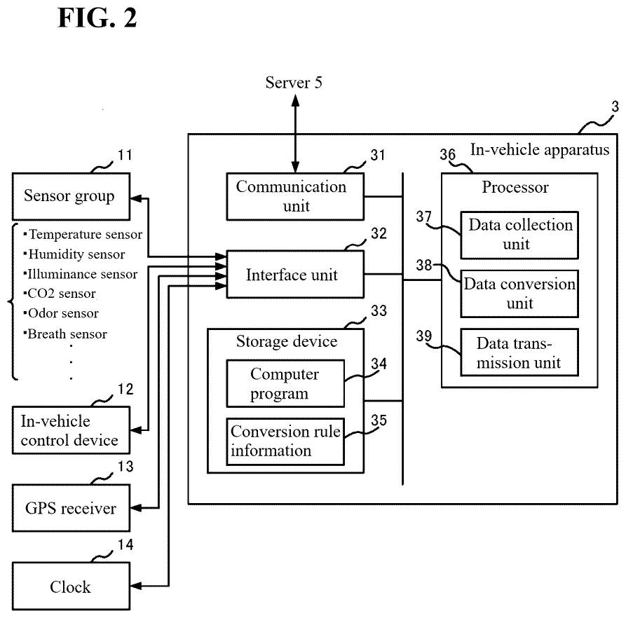

FIG. 2 is a block diagram showing an example of the configuration of in-vehicle apparatus 3.

In-vehicle apparatus 3 includes a communication unit 31, an interface unit 32, a storage device 33, and a processor 36. Communication unit 31, interface unit 32, storage device 33, and processor 36 are connected to each other via buses or the like.

Communication unit 31 includes a communication module for connecting in-vehicle apparatus 3 to network 8 wirelessly. Communication unit 31 transmits and receives data to and from other devices via network 8. Communication unit 31 may be provided in a device different from in-vehicle apparatus 3.

Interface unit 32 connects a sensor group 11, an in-vehicle control device 12, a global positioning system (GPS) receiver 13, and a clock 14, which are mounted on vehicle 2, to in-vehicle apparatus 3.

Storage device 33 is configured by a volatile memory element such as a static random access memory (SRAM) or a dynamic random access memory (DRAM), a nonvolatile memory element such as a flash memory or an electrically erasable programmable read only memory (EEPROM), a magnetic storage device such as a hard disk, or the like.

Storage device 33 stores a computer program 34 to be executed by processor 36. Storage device 33 stores data used or generated when computer program 34 is executed. The data used or generated when computer program 34 is executed includes, for example, a conversion rule information 35 described later.

Processor 36 is configured by a central processing unit (CPU) or the like, and includes a data collection unit 37, a data conversion unit 38, and a data transmission unit 39 as functional processing units provided by reading and executing computer program 34 stored in storage device 33.

Data collection unit 37 collects vehicle data from sensor group 11, in-vehicle control device 12, GPS receiver 13, and clock 14 via interface unit 32.

Sensor group 11 includes sensors that output measured values related to the state of vehicle 2, such as the driving state of vehicle 2 or the indoor environment of vehicle 2. Sensor group 11 includes, for example, a temperature sensor, an illuminance sensor, a carbon dioxide (hereinafter, referred to as CO2) sensor, an odor sensor, and a breath sensor.

The temperature sensor measures the temperature inside vehicle 2 or the temperature outside vehicle 2. The humidity sensor measures the humidity inside vehicle 2 or the humidity outside vehicle 2. The illuminance sensor measures the illuminance in vehicle 2.

The CO2 sensor measures the amount of CO2 in vehicle 2. When the ventilation in vehicle 2 is insufficient, the amount of CO2 increases. Maintaining the amount of CO2 at a certain level or less is effective for preventing an occupant from falling asleep or preventing infection. It is noted that, the CO2 sensor may measure the CO2 concentration instead of the amount of CO2.

The odor sensor measures the amount of odor in vehicle 2. The amount of odor is represented by, for example, the concentration of a volatile organic compound as a source substance. Volatile organic compounds include, for example, formaldehyde, acetaldehyde, toluene, xylene, ethylbenzene. The breath sensor measures the breath alcohol concentration of the occupant of vehicle 2.

Data collection unit 37 collects measurement results (temperature, humidity, illuminance, amount of CO2, amount of odor, amount of alcohol, and the like) of the sensors as vehicle data. Data collection unit 37 may collect the CO2 concentration instead of the amount of CO2.

Further, data collection unit 37 collects data flowing on the in-vehicle network of vehicle 2 as vehicle data. When the in-vehicle network is configured by a controller area network (CAN), data flowing on the in-vehicle network is referred to as CAN information. The CAN information is, for example, information output by in-vehicle control device 12 such as an electronic control unit (ECU), and includes, for example, information such as the acceleration, angular velocity, engine speed, battery voltage, fuel remaining amount, and state of charge (SOC) of vehicle 2.

Further, data collection unit 37 collects the position information of vehicle 2 measured by GPS receiver 13 as vehicle data. The position information of vehicle 2 is indicated by, for example, latitude, longitude, and altitude. Furthermore, data collection unit 37 collects the current time information output from clock 14.

Data conversion unit 38 converts the set of vehicle data collected by data collection unit 37 into format data. The format data indicates data in a predetermined data format. It is noted that, in the following description, the “set of vehicle data” is also referred to as “vehicle data”.

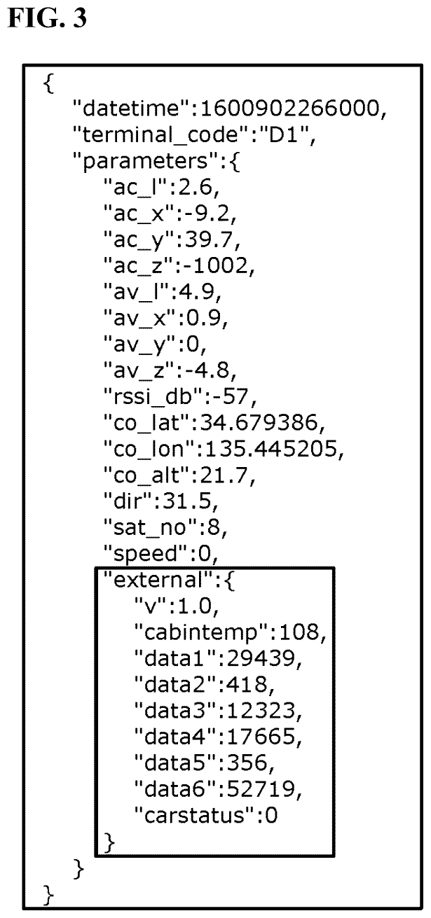

FIG. 3 is a diagram showing an example of the data structure of format data. The format data includes a time stamp indicated by a tag “datetime”, an identifier of in-vehicle apparatus 3 indicated by a tag “terminal_code” (hereinafter, referred to as an “in-vehicle apparatus ID”), and a structure of vehicle data indicated by a tag “parameters”. The value “1600902266000” of the time stamp is calculated based on the current time information collected from clock 14. The value “D1” of the in-vehicle apparatus ID is stored in storage device 33 in advance. Data conversion unit 38 reads the in-vehicle apparatus ID “D1” from storage device 33 and writes it in the format data.

The structure of the vehicle data indicated by the tag “parameters” includes vehicle data collected from the CAN information, vehicle data collected from GPS receiver 13, and vehicle data collected from sensor group 11.

Of the structure of the vehicle data indicated by the tag “parameters”, the vehicle data other than the structure of the vehicle data indicated by the tag “external” is the vehicle data (hereinafter, referred to as “standard data”) transmitted from vehicle 2 in a standard manner. The standard data is data transmitted in common by all vehicles 2. The standard data includes, for example, vehicle data indicated by tags “ac_l”, “ac_x”, “ac_y”, “ac_z”, “av_l”, “av_x”, “av_y”, “av_z”, “rssi_db”, “co_lat”, “co_log”, “co_alt”, “dir” “sat_no”, and “speed”. As an example, vehicle data indicated by a tag “ac_l” represents an average acceleration (scalar). The vehicle data indicated by the tag “ac_x” represents a preset average acceleration in the x-axis direction. The vehicle data indicated by the tag “ac_y” represents a preset average acceleration in the y-axis direction. The vehicle data indicated by the tag “ac_z” represents a preset acceleration in the z-axis direction. The vehicle data indicated by the tags “co_lat”, “co_log”, and “co_alt” respectively represent the latitude, longitude, and altitude of vehicle 2. The vehicle data indicated by the tag “dir” represents the direction of vehicle 2. The vehicle data indicated by the tag “spd” represents the speed of vehicle 2.

The vehicle data included in the data of the structure indicated by the tag “external” (hereinafter, referred to as “external data”) is different in type for each vehicle 2. The external data includes a version (data indicated by a tag “v”) corresponding to the type of the vehicle data included in the external data. That is, the type of vehicle data included in the external data and the sequence of vehicle data are defined by the version. The type of the vehicle data indicates the type of the measurement result of the sensor. For example, since temperature indicates the measurement result of the temperature sensor and humidity indicates the measurement result of the humidity sensor, the types of the measurement results of the sensors are different from each other. Thus, the type of the vehicle data indicating the temperature is different from the type of the vehicle data indicating the humidity. The type of the vehicle data may indicate the type of the measurement result indicated by the vehicle data and the type of the sensor that outputs the measurement result. In this case, for example, even when two pieces of vehicle data indicate the temperature in vehicle 2, when the type of the sensor for measuring the temperature is different, the type of the vehicle data is different. Conversion rule information 35 includes information indicating the type of vehicle data included in the external data and the sequence of vehicle data for each version. Further, conversion rule information 35 includes a conversion rule for converting the vehicle data into the format data for each version.

The external data includes data indicated by tags “cabintemp”, “data 1”, “data 2”, “data 3”, “data 4”, “data 5”, “data 6”, and “carstatus”, for example, as vehicle data of version 1.0. The data indicated by the tag “cabintemp” is 8-bit data and indicates the temperature in vehicle 2. The data indicated by the tags “data 1”, “data 2”, “data 3”, “data 4”, “data 5”, and “data 6” is 16-bit data. Each of these data is data being one vehicle data or generated by combining two or more vehicle data. For example, data indicated by a tag “data 1” represents the relative humidity in vehicle 2 and the voltage of the battery mounted on vehicle 2. The data indicated by the tag “data 2” represents the illuminance in vehicle 2. The data indicated by the tag “data 3” represents the fuel remaining amount of vehicle 2 and the speed of vehicle 2. The data indicated by the tag “data 4” represents the temperature outside vehicle 2 (outside air temperature) and the fuel type of vehicle 2 (fuel type). The data indicated by the tag “data 5” represents the fuel consumption amount of vehicle 2. The data indicated by the tag “data 6” represents the intake air amount of vehicle 2 measured by a mass flow sensor (MAF). The data indicated by the tag “carstatus” is 8-bit data, and represents the engine state (engine speed) of vehicle 2.

Data conversion unit 38 converts the vehicle data collected by data collection unit 37 into external data according to a predetermined conversion rule. For example, data conversion unit 38 converts the temperature in vehicle 2 collected by data collection unit 37 into data indicated by the 8-bit tag “cabintemp” in accordance with a predetermined calculation formula. Data conversion unit 38 generates one piece of data by combining a plurality of pieces of data after conversion in accordance with a predetermined combination rule. For example, data conversion unit 38 generates data indicated by a tag “data 1”, by combining the converted humidity in vehicle 2 and the converted battery voltage. It is assumed that, the conversion rule and the combination rule including the calculation formula are stored in conversion rule information 35.

Data transmission unit 39 transmits the format data generated by the conversion of data conversion unit 38 to server 5 via communication unit 31.

### Configuration of Server 5

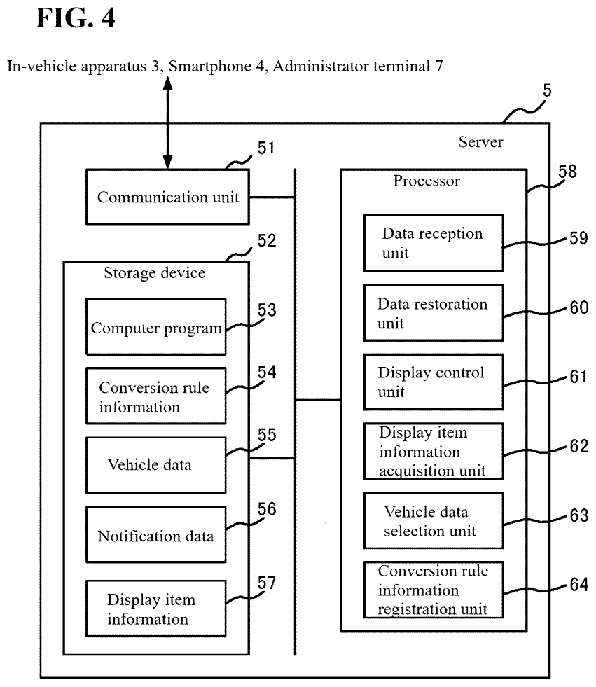

FIG. 4 is a block diagram showing an example of the configuration of server 5. Server 5 includes a communication unit 51, a storage device 52, and a processor 58. Communication unit 51, storage device 52, and processor 58 are connected to each other via buses or the like.

Communication unit 51 includes a communication module for connecting server 5 to network 8 wirelessly or by wired connection. Communication unit 51 transmits and receives data to and from other devices via network 8.

Storage device 52 is configured by a volatile memory element such as an SRAM or a DRAM, a nonvolatile memory element such as a flash memory or an EEPROM, or a magnetic storage device such as a hard disk, or the like.

Storage device 52 stores a computer program 53 executed by processor 58. Further, storage device 52 stores data used or generated when computer program 53 is executed. The data used or generated when computer program 53 is executed includes, for example, a conversion rule information 54, a vehicle data 55, a notification data 56, and a display item information 57.

Conversion rule information 54 includes a conversion rule for converting the format data and restoring the vehicle data from the format data. Conversion rule information 54 includes a conversion rule for each version of format data. Vehicle data 55 is a set of vehicle data restored from the format data. Notification data 56 is notification data transmitted from smartphone 4. Display item information 57 is information indicating the type of the vehicle data to be displayed.

Processor 58 is configured by a CPU or the like. Processor 58 reads and executes computer program 53 stored in storage device 52. Processor 58 includes, as functional processing units, a data reception unit 59, a data restoration unit 60, a display control unit 61, a display item information acquisition unit 62, a vehicle data selection unit 63, and a conversion rule information registration unit 64.

Data reception unit 59 receives data transmitted by in-vehicle apparatus 3, smartphone 4, and administrator terminal 7 via communication unit 51. Specifically, data reception unit 59 receives format data transmitted by in-vehicle apparatus 3. Data reception unit 59 may write the received format data in storage device 52 as it is. Data reception unit 59 receives notification data transmitted by smartphone 4. Data reception unit 59 receives various kinds of information such as information about instruction for displaying screen transmitted by administrator terminal 7.

Data restoration unit 60 restores the vehicle data from the format data based on the version indicated in the format data received by data reception unit 59. More specifically, data restoration unit 60 reads the version from the external data in the format data, and reads conversion rule information 54 corresponding to the read version from storage device 52. Data restoration unit 60 restores the vehicle data by converting the vehicle data included in the external data of the format data based on read conversion rule information 54.

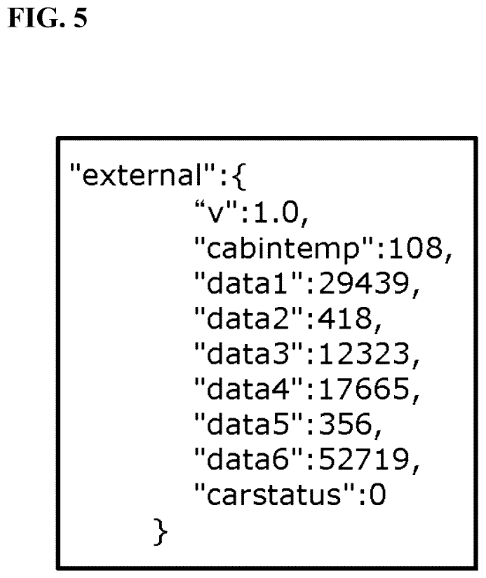

Hereinafter, an example of a restoring method of vehicle data will be described. FIG. 5 is a diagram showing an example of external data included in format data. The external data includes vehicle data of which the version indicated by the tag “v” is 1.0. That is, the external data includes data indicated by the tags “cabintemp”, “data 1”, “data 2”, “data 3”, “data 4”, “data 5”, “data 6”, and “carstatus”, respectively.

The value of data indicated by the tag “cabintemp” is 108 in decimal representation. The value of data indicated by the tag “data 1” is 29439 in decimal representation. The value of data indicated by the tag “data 2” is 418 in decimal representation. The value of data indicated by the tag “data 3” is 12323 in decimal representation. The value of data indicated by the tag “data 4” is 17665 in decimal representation. The value of data indicated by the tag “data 5” is 356 in decimal representation. The value of data indicated by the tag “data 6” is 52719 in decimal representation. The value of data indicated by the tag “carstatus” is zero in decimal representation. The type, sequence, and size of each vehicle data are defined in conversion rule information 54 for each version.

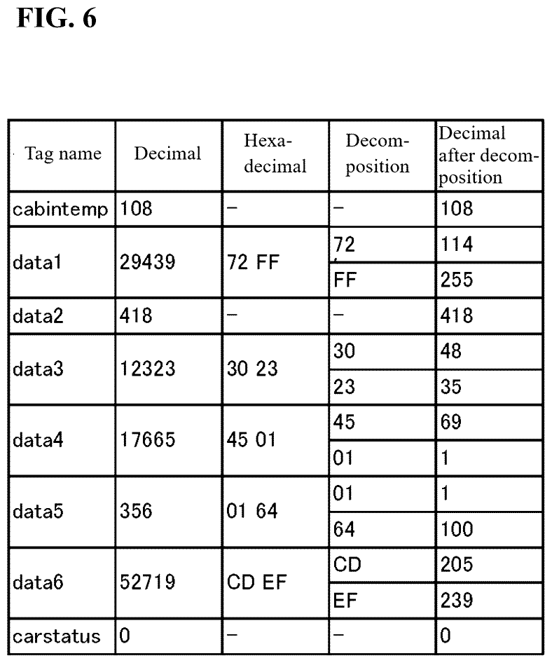

FIG. 6 is a diagram for explaining a conversion process of vehicle data. The table shown in FIG. 6 includes five columns (tag name, decimal, hexadecimal, decomposition, decimal after decomposition). The “tag name” indicates an item (tag name) of data included in the external data. The “decimal” indicates the value of the decimal representation of the data. Data restoration unit 60 extracts the value of the decimal representation indicated by “decimal” for each item of the data indicated by “item” from the external data.

The “hexadecimal” indicates a value of the hexadecimal representation of the data. Here, the item of data which is a target of the hexadecimal representation is stored in conversion rule information 54 for each version. Data restoration unit 60 represents the target data (here, the value of the decimal representation indicated by the tags “data 1”, “data 3”, “data 4”, “data 5”, and “data 6”) in hexadecimal representation based on conversion rule information 54 and the version of the external data.

Data restoration unit 60 decomposes the value represented in the hexadecimal representation into data of the upper two digits and data of the lower two digits, and respectively represents the data in the decimal representation.

The “decomposition” indicates data of the upper two digits and the lower two digits obtained by decomposing value in hexadecimal representation. The “decimal after decomposition” indicates data in decimal representation of the data in hexadecimal representation after decomposition. Further, “decimal after decomposition” indicates data of decimal representation for data which is not a target of the hexadecimal representation. For example, the decimal representation of data indicated by the tag “data 1” is 29439, and the hexadecimal representation of the data is 72FF. Furthermore, the data in the hexadecimal representation is decomposed into data in the decimal representation, which are 114 and 255.

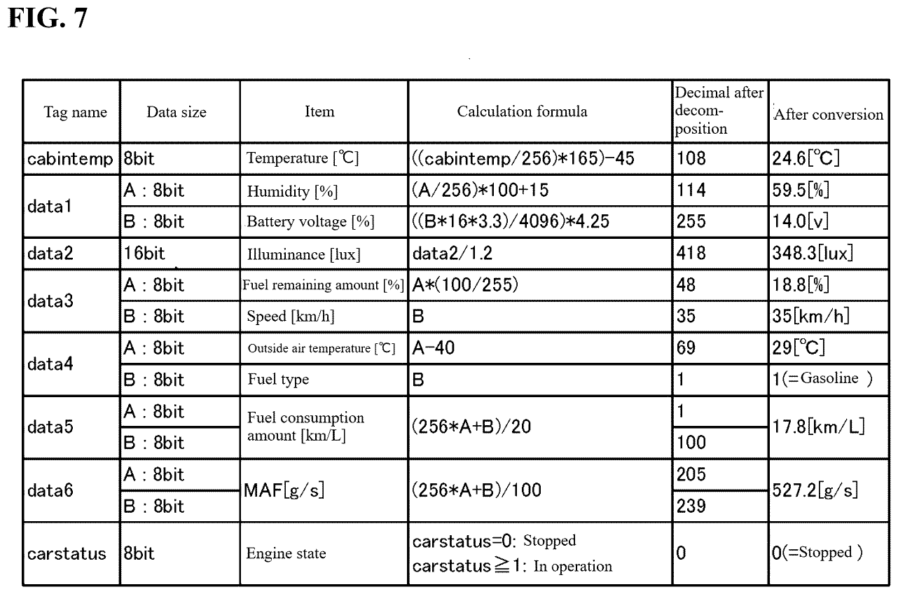

FIG. 7 is a diagram for explaining a conversion process of vehicle data. The table shown in FIG. 7 includes six columns (tag name, data size, item, calculation formula, decimal after decomposition, after conversion). The “tag name” is the same as that shown in FIG. 6, and indicates the item (tag name) of the data included in the external data. The “data size” indicates the size of data indicated by the tag name. It is noted that, in the case of data which is a target of the hexadecimal representation, the “data size” indicates the size of data of the upper two digits and the size of data of the lower two digits. The “item” indicates an item of the vehicle data after the conversion. The “calculation formula” indicates a calculation formula for converting the data indicated in the “decimal after decomposition”. The “decimal after decomposition” indicates a value of decimal representation before conversion. The value of “decimal after decomposition” is the same as “decimal after decomposition” shown in FIG. 6. The “after conversion” indicates the value after the value indicated in the “decimal after decomposition” is converted in accordance with the calculation formula indicated in the “calculation formula”.

The calculation formula indicated in the “calculation formula” is stored in conversion rule information 54 for each version. For example, data restoration unit 60 substitutes the value 108 of “decimal after decomposition” of the tag “cabintemp” into the variable cabintemp of the calculation formula “((cabintemp/256)*165)−45”, thereby deriving temperature 24.6 °C. Further, data restoration unit 60 substitutes the value 114 of the upper “decimal after decomposition” of the tag “data 1” into the variable A of the calculation formula “(A/256)*100+15” to derive the humidity 59.5%. Furthermore, data restoration unit 60 also substitutes the value 1 of the upper “decimal after decomposition” and the value 100 of the lower “decimal after decomposition” of the tag “data 5” into the variable A and the variable B of the calculation formula “(256*A+B)/20”, respectively, to derive the fuel consumption amount 17.8 km/L.

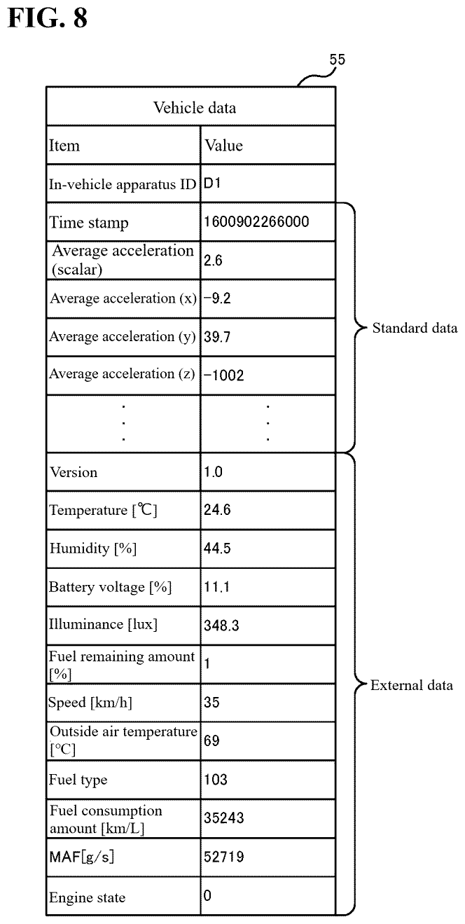

FIG. 8 is a diagram showing an example of vehicle data 55 restored by converting format data. Vehicle data 55 includes an in-vehicle apparatus ID, standard data, and external data. The in-vehicle apparatus ID includes data indicated by the tag “terminal_code” of the format data shown in FIG. 3. The standard data includes data other than data indicated by the tag “external” in the structure of the vehicle data indicated by the tag “parameters” of the format data. The external data includes the version of the external data and the value of the external data after the conversion shown in FIG. 7.

Data restoration unit 60 stores restored vehicle data 55 in storage device 52 for each in-vehicle apparatus ID.

Display control unit 61 transmits screen information including at least one of vehicle data 55 and notification data 56 stored in storage device 52 to administrator terminal 7 via communication unit 51. Thus, administrator terminal 7 is caused to display screen information including at least one of vehicle data 55 and notification data 56.

Display item information acquisition unit 62 receives display item information indicating the type of vehicle data that the administrator of vehicle 2 desires to display from administrator terminal 7 via communication unit 51. Display item information acquisition unit 62 stores received display item information 57 in storage device 52.

Vehicle data selection unit 63 selects vehicle data of the type indicated by display item information 57 from vehicle data 55 stored in storage device 52. Vehicle data selection unit 63 outputs the selected vehicle data to display control unit 61. Display control unit 61 generates screen information including the vehicle data selected by vehicle data selection unit 63, and transmits the screen information to administrator terminal 7 via communication unit 51. Thus, administrator terminal 7 can be caused to display the screen information including the vehicle data selected based on display item information 57.

Further, when data reception unit 59 receives various kinds of information about instruction for displaying screen, vehicle data selection unit 63 selects vehicle data based on the instruction information from vehicle data 55. For example, when the information about the instruction for displaying screen of the vehicle data of vehicle 2 for which the alcohol check is not completed is received, vehicle data selection unit 63 selects the vehicle data of vehicle 2 for which the alcohol check is not completed from vehicle data 55. The selected vehicle data is displayed on administrator terminal 7 in the same manner as described above.

Conversion rule information registration unit 64 registers conversion rule information 54 by writing it in storage device 52. Further, conversion rule information registration unit 64 transmits conversion rule information for generating format data from vehicle data to in-vehicle apparatus 3 via communication unit 51, thereby registering the conversion rule information in in-vehicle apparatus 3. For example, conversion rule information registration unit 64 registers the conversion rule information when a new type of sensor is additionally mounted on vehicle 2. When a new type of sensor is additionally mounted, a measurement result of the additionally mounted sensor cannot be converted into format data by the known conversion rule information. Thus, conversion rule information registration unit 64 creates mutual conversion rule information between the new vehicle data and the format data, including the conversion rule of the measurement result of the additionally mounted sensor. Furthermore, conversion rule information registration unit 64 also assigns a new version to the new conversion rule information.

It is noted that, conversion rule information registration unit 64 may be provided in an external device of server 5. For example, administrator terminal 7 may be provided with conversion rule information registration unit 64, and administrator terminal 7 may register the conversion rule information of in-vehicle apparatus 3 and server 5.

### Configuration of Administrator Terminal 7

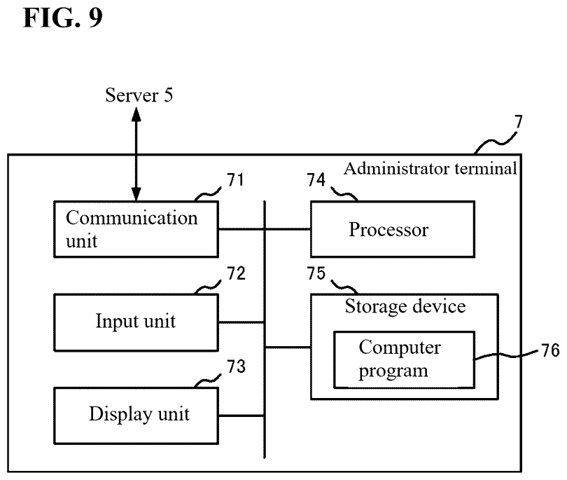

FIG. 9 is a block diagram showing an example of the configuration of administrator terminal 7. Administrator terminal 7 includes a communication unit 71, an input unit 72, a display unit 73, a processor 74, and a storage device 75. Communication unit 71, input unit 72, display unit 73, processor 74, and storage device 75 are connected to each other via buses, communication lines, or the like.

Communication unit 71 includes a communication module for connecting administrator terminal 7 to network 8 wirelessly or by wired connection. Communication unit 71 transmits and receives data to and from other devices via network 8.

Input unit 72 is an input device used by the administrator who uses administrator terminal 7 to input data, and includes, for example, a keyboard or a mouse.

Display unit 73 is an output device for displaying data, and includes, for example, a display using liquid crystal or organic electroluminescence (EL). Processor 74 is configured by a CPU or the like, and performs processing such as computation in accordance with a computer program.

Storage device 75 is configured by a volatile memory element such as an SRAM or a DRAM, a nonvolatile memory element such as a flash memory or an EEPROM, a magnetic storage device such as a hard disk, or the like. Storage device 75 stores a computer program 76 executed by processor 74. Further, storage device 75 stores data used or generated when computer program 76 is executed.

Processor 74 receives screen information for display from server 5 via communication unit 71, and causes display unit 73 to display the received screen information.

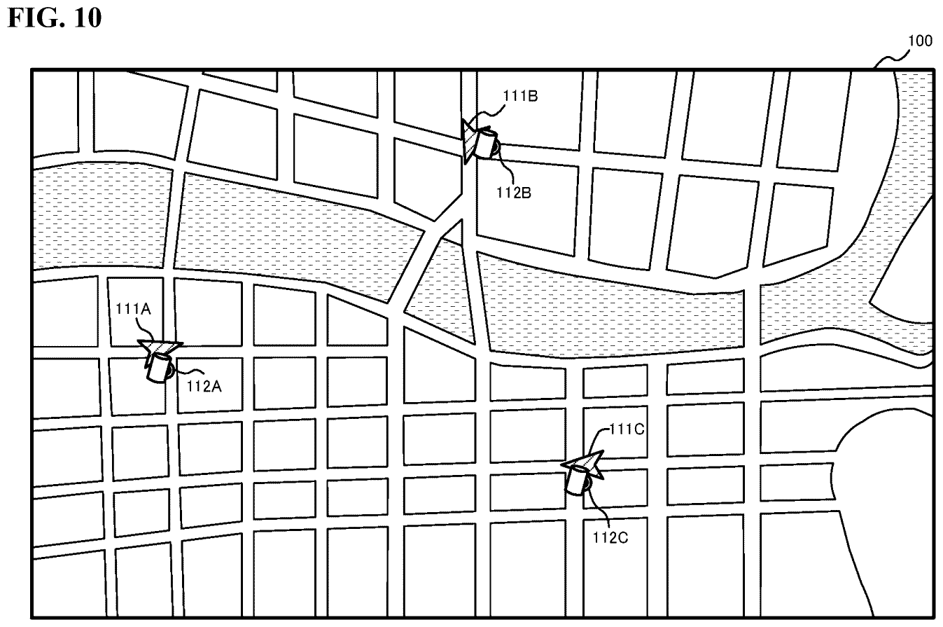

FIG. 10 is a view showing an example of screen information displayed on display unit 73. A vehicle data screen 100 shown in FIG. 10 is an example of the screen information, and shows the position of vehicle 2 in which an occupant who has not completed the breath alcohol concentration check (alcohol check) is riding.

Vehicle data screen 100 includes, for example, vehicle icons 111A, 111B, and 111C and beer mug icons 112A, 112B, and 112C on a map. Hereinafter, vehicle icons 111A, 111B, and 111C are referred to as vehicle icons 111 when they are not distinguished from each other, and beer mug icons 112A, 112B, and 112C are referred to as beer mug icons 112 when they are not distinguished from each other.

Vehicle icon 111 is displayed at a position on the map of vehicle 2 for which the alcohol check has not been completed. The direction of the tip portion indicated by vehicle icon 111 represents the traveling direction of vehicle 2. For example, it is understood that vehicle 2 indicated by vehicle icon 111A is traveling from the left side to the right side of the drawing. Beer mug icon 112 is displayed near vehicle icon 111. Beer mug icon 112 is an icon indicating that the alcohol check of the occupant is not completed. It is noted that, vehicles 2 that similarly indicate abnormal values for the amount of CO2 in vehicle 2 and the amount of odor in vehicle 2 (for example that indicate the amount of CO2 or the amount of odor is equal to or greater than a predetermined threshold value) may be shown on the map with vehicle icon 111. Further, an icon indicating the type of vehicle data indicating an abnormal value may be displayed near vehicle icon 111. It is noted that, the CO2 concentration in vehicle 2 may be used instead of the amount of CO2 in vehicle 2.

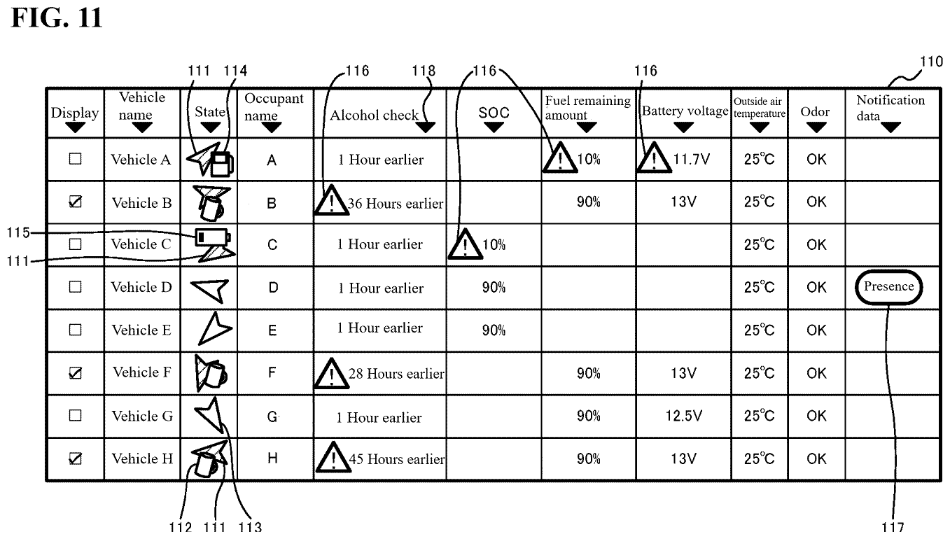

FIG. 11 is a diagram showing an example of screen information displayed on display unit 73. A vehicle data screen 110 shown in FIG. 11 is an example of the screen information, and shows a list of vehicle data of vehicle 2 managed by the administrator. For example, vehicle data screen 110 includes a plurality of records each including eleven items (display, vehicle name, state, occupant name, alcohol check, SOC, fuel remaining amount, remaining battery level, outside air temperature, odor, and notification data) for each vehicle 2.

The item “display” indicates whether or not the position of vehicle 2 is indicated by vehicle icon 111 superimposed on the map in vehicle data screen 100 as shown in FIG. 10. The positions of vehicles 2 (here, the vehicles having the vehicle names of vehicle B, vehicle F, and vehicle H) for which the item “display” is checked are indicated in vehicle data screen 100.

The item “vehicle name” indicates a list of names of vehicles 2 managed by the administrator. The name of vehicle 2 managed by the administrator is managed by server 5 in association with, for example, the in-vehicle apparatus ID.

The item “state” is an icon indicating the state of vehicle 2 or the occupant of vehicle 2. An icon indicated by the item “state” is displayed superimposed on the map in vehicle data screen 100. For example, vehicle icon 111 indicating that some abnormality has occurred in vehicle 2 or the occupant of vehicle 2 is displayed on the map, and an icon indicating what the abnormality is, is displayed near vehicle icon 111.

The icons indicating what the abnormality is include, for example, beer mug icon 112, a gas station icon 114, and a battery icon 115. When beer mug icon 112 is displayed, it indicates that the alcohol check of the occupant of vehicle 2 has not been completed as described above. When gas station icon 114 is displayed, it indicates that the fuel remaining amount of vehicle 2 is reduced (for example, the fuel remaining amount is less than the predetermined fuel remaining amount threshold value). When battery icon 115 is displayed, it indicates that the SOC of the battery of vehicle 2 is abnormal (for example, the SOC is less than a predetermined SOC threshold value).

Further, a vehicle icon 113 indicating that no abnormality is detected from vehicle 2 or the occupant of vehicle 2 is displayed on the map.

Both vehicle icon 111 and vehicle icon 113 represent the position of vehicle 2 and the direction of the tip portion represents the traveling direction of vehicle 2. As an example, the display modes of vehicle icon 111 and vehicle icon 113 are made different by the presence or absence of hatching. Thus, the administrator can easily identify whether or not an abnormality has been detected in vehicle 2.

The item “occupant name” indicates the name of the occupant of vehicle 2. The name of the occupant of vehicle 2 managed by the administrator is, for example, managed by server 5 in association with the in-vehicle apparatus ID.

The item “alcohol check” indicates the elapsed time since the occupant measured the breath alcohol concentration using the breath sensor installed in vehicle 2 and the measurement result was last determined to be less than the standard value (hereinafter referred to as “elapsed time after alcohol check”). When the elapsed time after alcohol check is equal to or greater than the predetermined time threshold value, a warning icon 116 is displayed near the elapsed time after the alcohol check.

The item “SOC” indicates the SOC of the battery mounted on vehicle 2. When the SOC is less than the predetermined SOC threshold value, warning icon 116 is displayed near the SOC.

The item “fuel remaining amount” indicates the fuel remaining amount of vehicle 2. Here, the fuel remaining amount is a percentage of the remaining amount of fuel with respect to the tank capacity of fuel such as gasoline. When the fuel remaining amount is less than the predetermined fuel remaining amount threshold value, warning icon 116 is displayed near the fuel remaining amount.

The item “battery voltage” indicates the voltage of the battery mounted on vehicle 2. When the battery voltage is less than the predetermined battery voltage threshold value, warning icon 116 is displayed near the battery voltage threshold value. The item “outside air temperature” indicates the temperature (outside air temperature) outside vehicle 2.

The item “odor” indicates the determination result of odor based on the amount of odor in vehicle 2. When the amount of odor is less than the predetermined amount of odor threshold value, “OK” is displayed, and when the amount of odor is equal to or greater than the amount of odor threshold value, “NG” is displayed.

The item “notification data” indicates the presence or absence of notification data notified by the occupant of vehicle 2. When a notification icon 117 is displayed, it indicates that there is notification data. When notification icon 117 is not displayed, it indicates that there is no notification data.

Each item is provided with a sort button 118 having, for example, an inverted triangular shape. When the administrator presses sort button 118 of any item, processor 74 sorts and displays the records in ascending or descending order of the value of the item to which pressed sort button 118 belongs.

It is assumed that, although vehicle data 55 of version 1.0 shown in FIG. 8 does not include breath alcohol concentration, SOC, and amount of odor, vehicle data 55 of other versions includes these data.

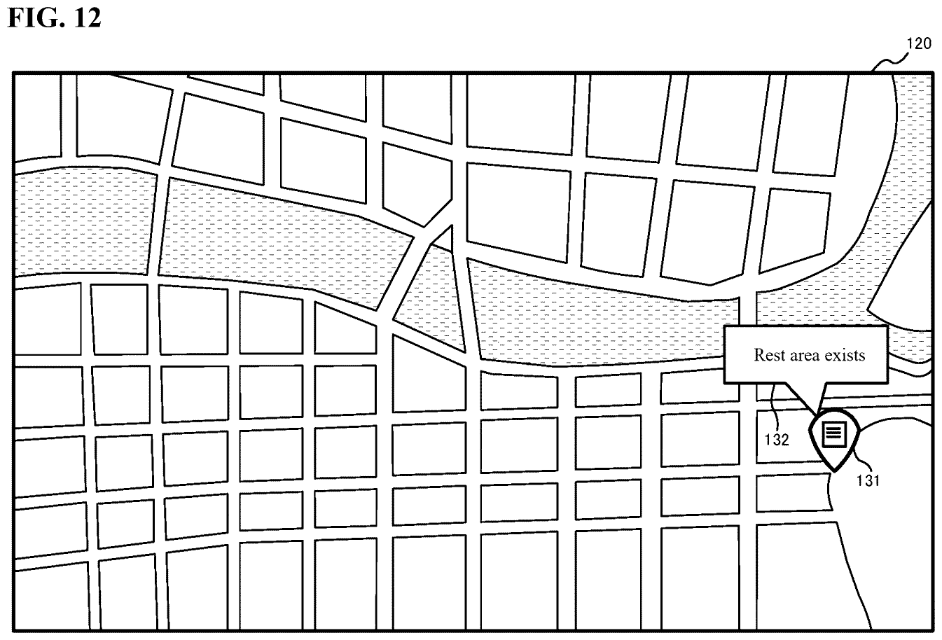

FIG. 12 is a diagram showing an example of screen information displayed on display unit 73. A vehicle data screen 120 shown in FIG. 12 is an example of the screen information, and shows the notification position of the notification data by vehicle 2 and the contents of the notification data.

Vehicle data screen 120 shows, for example, a notification icon 131 at the notification position of the notification data on the map, and a notification data content 132 near notification icon 131. The administrator can know that the rest area is present at the position of notification icon 131 by viewing vehicle data screen 120.

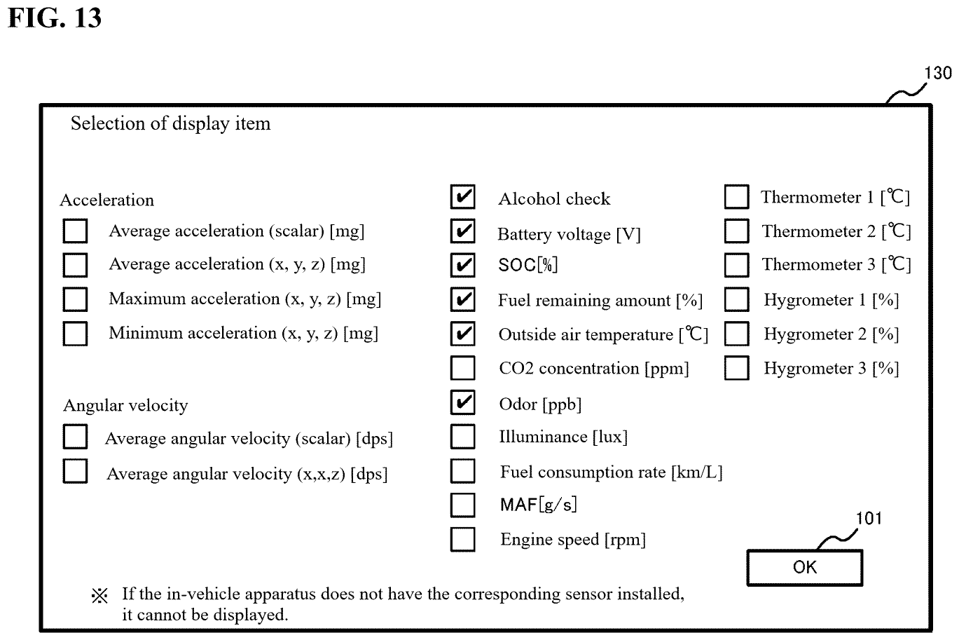

FIG. 13 is a diagram showing an example of screen information displayed on display unit 73. A settings screen 130 shown in FIG. 13 is an example of the screen information, and is a screen for selecting the display item indicating the type of the vehicle data to be displayed in vehicle data screen 110 shown in FIG. 11.

Vehicle data screen 110 displays a list of candidates for the display item and check boxes on the left side of the candidates. The administrator operates input unit 72 to check the check box and presses an OK button 101. As a result, the checked candidate is selected as the display item. For example, the administrator selects alcohol check, battery voltage, SOC, fuel remaining amount, outside air temperature, and odor as display items. Processor 74 transmits display item information indicating the selected display item to server 5 via communication unit 71.

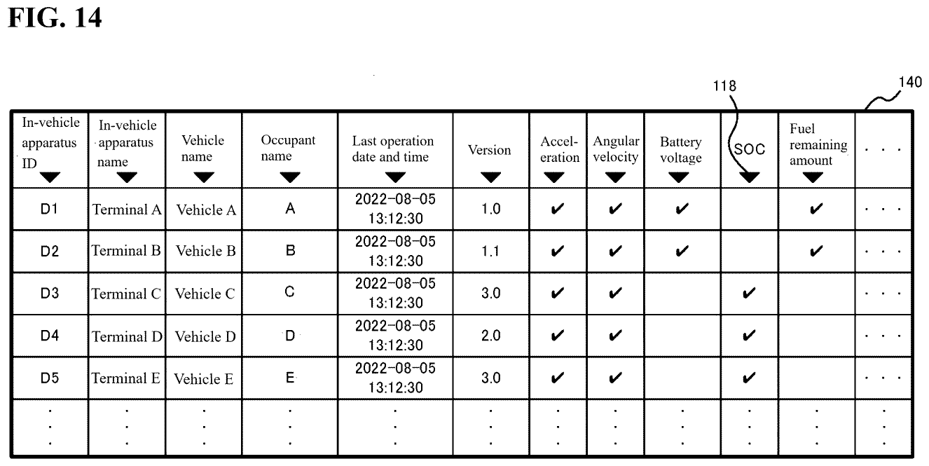

FIG. 14 is a diagram showing an example of screen information displayed on display unit 73. A management screen 140 shown in FIG. 14 shows a list of information related to vehicle 2 managed by the administrator.

Management screen 140 includes a plurality of records each including an in-vehicle apparatus ID, an in-vehicle apparatus name, a vehicle name, an occupant name, a last operation date and time, a version, an acceleration, an angular velocity, a battery voltage, an SOC, a fuel remaining amount, and the like. The “in-vehicle apparatus ID” is an identifier of in-vehicle apparatus 3 installed in vehicle 2. The “in-vehicle apparatus name” is the name of in-vehicle apparatus 3. The “vehicle name” is the name of vehicle 2. The “occupant name” is the name of the occupant of vehicle 2. The “last operation date and time” indicates the last operation date and time of vehicle 2. The last operation date and time indicates, for example, the date and time when vehicle 2 is stopped, which is specified by server 5 based on the speed or the position of vehicle 2.

The “version” indicates the version of the external data. The “acceleration”, the “angular velocity”, the “battery voltage”, the “SOC”, the “fuel remaining amount”, and the like indicate each vehicle data of vehicle 2.

Each item is provided with sort button 118 having, for example, an inverted triangular shape. When the administrator presses sort button 118 of any item, processor 74 sorts and displays the records in ascending or descending order of the value of the item to which pressed sort button 118 belongs.

### Processing Procedure of Operation Management System 1

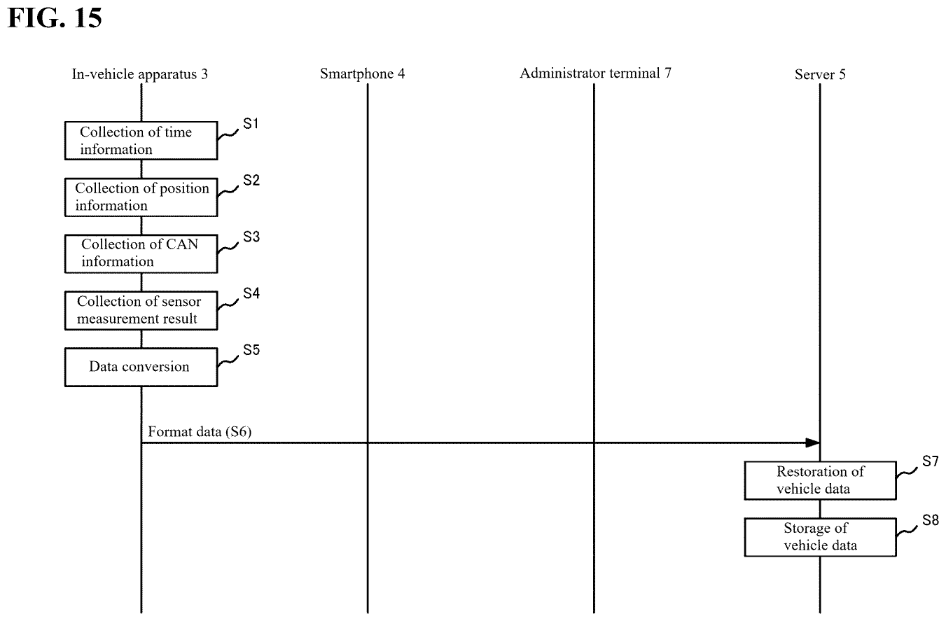

FIG. 15 is a sequence diagram showing an example of a processing procedure of operation management system 1. FIG. 15 shows a processing procedure of a collection processing of vehicle data from in-vehicle apparatus 3. Data collection unit 37 of in-vehicle apparatus 3 collects the current time information from clock 14 (step S1).

Data collection unit 37 of in-vehicle apparatus 3 collects the position information of vehicle 2 from GPS receiver 13 (step S2).

Data collection unit 37 of in-vehicle apparatus 3 collects CAN information flowing on the in-vehicle network of vehicle 2 (step S3).

Data collection unit 37 of in-vehicle apparatus 3 collects the measurement result by sensor group 11 installed in vehicle 2 (step S4).

Data conversion unit 38 of in-vehicle apparatus 3 converts the data collected by the processing from step S1 to step S4 into format data (step S5). An example of the format data is as shown in FIG. 3.

Data transmission unit 39 of in-vehicle apparatus 3 transmits the format data generated by the processing of step S4 to server 5, and data reception unit 59 of server 5 receives the format data (step S6).

Data restoration unit 60 of server 5 restores the vehicle data from the format data received in step S6 (step S7). An example of the restored vehicle data is as shown in FIG. 8.

Data restoration unit 60 of server 5 stores the restored vehicle data in storage device 52 for each of the in-vehicle apparatus IDs (step S8). The processing shown in FIG. 15 is repeatedly executed at a predetermined cycle.

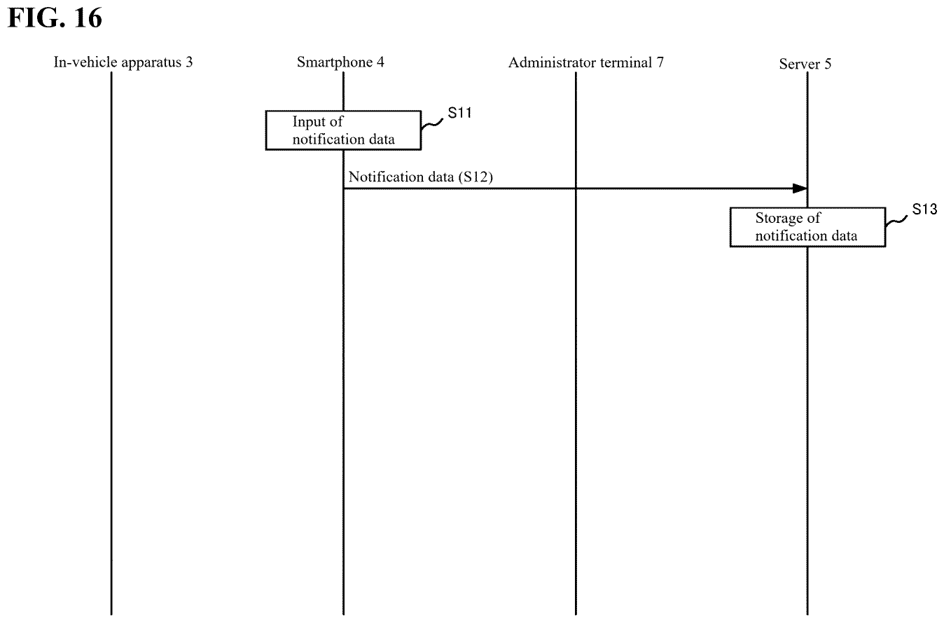

FIG. 16 is a sequence diagram showing an example of a processing procedure of operation management system 1. FIG. 16 shows a processing procedure of the collection processing of notification data from smartphone 4.

The occupant of vehicle 2 operates smartphone 4 and inputs notification data at a position where information useful for the operation of vehicle 2 is obtained (step S11). For example, the occupant starts an application for collecting notification data and inputs a number corresponding to the type of notification data. For example, the rest area of vehicle 2, the place of traffic regulation by the police, the place of traffic accident, and the place where there was some kind of complaint are associated with No. 1, No. 2, No. 3, and No. 4, respectively.

Smartphone 4 sends the notification data input at step S11 to server 5 with vehicle 2's position information and the in-vehicle apparatus ID of in-vehicle apparatus 3 attached, and server 5 receives the notification data with the added position information and in-vehicle apparatus ID (step S12). For example, when the occupant operates smartphone 4 to input the No. 1 corresponding to the rest area, the numerical value “1” as the notification data, the position information, and the in-vehicle apparatus ID are transmitted to server 5.

Server 5 stores the notification data to which the position information and the in-vehicle apparatus IDs received in step S 12 are added in storage device 52 (step S13).

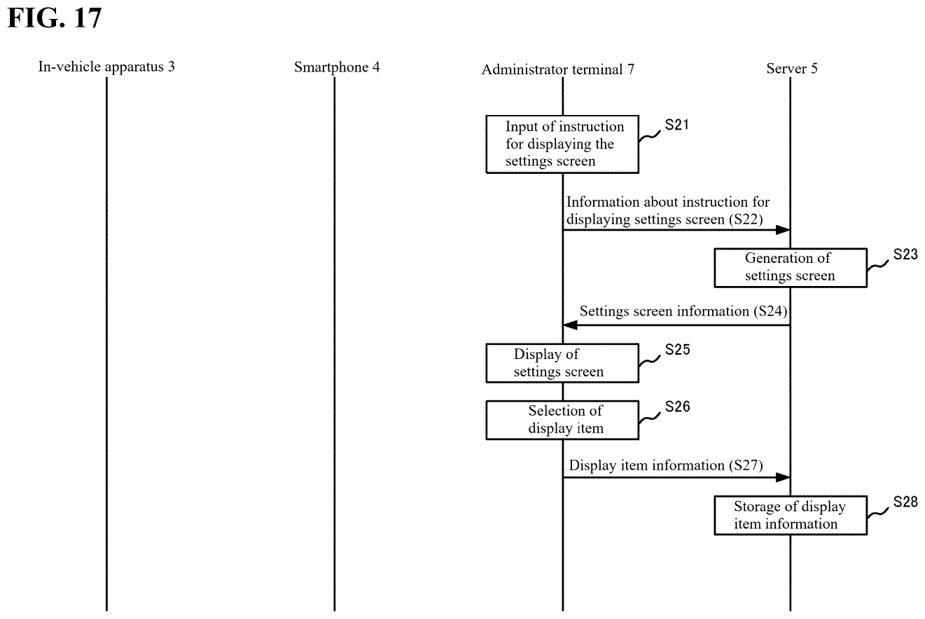

FIG. 17 is a sequence diagram showing an example of a processing procedure of operation management system 1. FIG. 17 shows a processing procedure of a selection process of a display item to be displayed in administrator terminal 7.

The administrator inputs an instruction for displaying the settings screen, which is a screen for selecting the display item, using input unit 72 of administrator terminal 7 (step S21).

Processor 74 of administrator terminal 7 transmits information about the instruction for displaying settings screen to server 5 in response to the input of the display instruction in step S21, and data reception unit 59 of server 5 receives the information (step S22).

Display control unit 61 of server 5 generates settings screen information for selecting the display item to be displayed in administrator terminal 7 based on the received information about the instruction for displaying settings screen (step S23).

Display control unit 61 of server 5 transmits the generated settings screen information to administrator terminal 7, and processor 74 of administrator terminal 7 receives the information (step S24).

Processor 74 of administrator terminal 7 causes display unit 73 to display the settings screen based on the received settings screen information (step S25). An example of the settings screen is shown in FIG. 13.

The administrator operates input unit 72 to select a display item from the settings screen (step S26).

Processor 74 of administrator terminal 7 transmits display item information indicating the selected display item to server 5, and display item information acquisition unit 62 of server 5 receives the display item information (step S27).

Processor 74 of administrator terminal 7 writes received display item information 57 in storage device 52 (step S28).

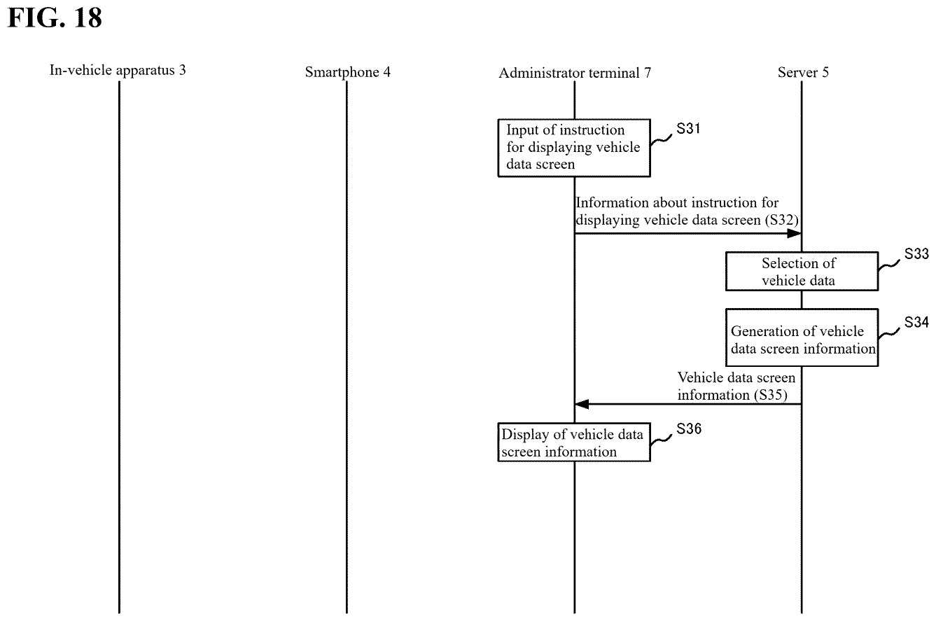

FIG. 18 is a sequence diagram showing an example of a processing procedure by operation management system 1. FIG. 18 shows a processing procedure of a display process of the vehicle data screen.

The administrator inputs an instruction for displaying the vehicle data screen using the input unit of administrator terminal 7 (step S31). Here, it is assumed that an instruction for displaying the position of vehicle 2, for which an alcohol check has not been completed, has been inputted.

Processor 74 of administrator terminal 7 transmits information about the instruction for displaying vehicle data screen to server 5 in response to the input of the display instruction in step S31, and data reception unit 59 of server 5 receives the information (step S32).

Vehicle data selection unit 63 of server 5 selects the vehicle data of vehicle 2 for which the alcohol check is not completed from vehicle data 55 based on the instruction information (step S33). Specifically, vehicle data selection unit 63 calculates the elapsed time after the alcohol check for each in-vehicle apparatus ID by referring to vehicle data 55. Vehicle data selection unit 63 selects latest vehicle data 55 of the in-vehicle apparatus ID in which the elapsed time after the alcohol check is equal to or greater than the predetermined time threshold value.

Display control unit 61 of server 5 generates vehicle data screen information based on vehicle data 55 selected in step S33 (step S34). For example, display control unit 61 generates vehicle data screen information for displaying a vehicle data screen on a map with vehicle icon 111 and beer mug icon 112 indicating the position of vehicle 2 where an alcohol check, as shown in FIG. 10, has not been completed.

Display control unit 61 of server 5 transmits the generated vehicle data screen information to administrator terminal 7, and processor 74 of administrator terminal 7 receives the information (step S35).

Display control unit 61 of server 5 displays vehicle data screen 100 as shown in FIG. 10 on display unit 73 based on the received vehicle data screen information (step S36).

The display process of vehicle data screen 110 as shown in FIG. 11 is also performed in accordance with the processing procedure shown in FIG. 18. Specifically, in step S31, the administrator inputs an instruction for displaying a list of vehicle data of vehicle 2 managed by the administrator.

In step S33, vehicle data selection unit 63 of server 5 reads latest vehicle data 55 for each of the in-vehicle apparatus IDs from storage device 52. Vehicle data selection unit 63 selects vehicle data of the type indicated by display item information 57 from the read vehicle data 55 by referring to display item information 57.

In step S34, display control unit 61 of server 5 generates vehicle data screen information for displaying vehicle data screen 110 as shown in FIG. 11, based on the selected vehicle data and notification data 56 stored in storage device 52. As a result, vehicle data screen 110 is displayed on administrator terminal 7 in step S35.

The display process of vehicle data screen 120 as shown in FIG. 12 is also performed in accordance with the processing procedure shown in FIG. 18. Specifically, in step S31, the administrator inputs an instruction for displaying the notification position of the notification data by vehicle 2 and the content of the notification data. In this case, the processing of step S33 is not executed.

In step S34, display control unit 61 generates notification data display screen information for displaying vehicle data screen 120 as shown in FIG. 12, instead of the vehicle data screen information, based on notification data 56 stored in storage device 52.

In step S35, display control unit 61 of server 5 transmits notification data display screen information to administrator terminal 7 instead of the vehicle data screen information, and processor 74 of administrator terminal 7 receives the information. In step S36, processor 74 causes display unit 73 to display vehicle data screen 120 as shown in FIG. 12.

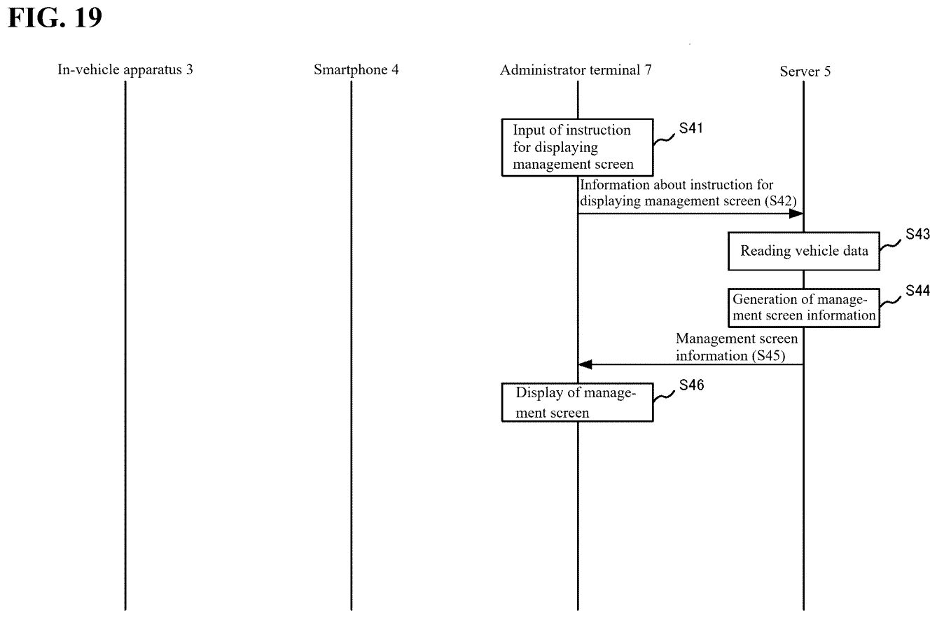

FIG. 19 is a sequence diagram showing an example of a processing procedure by operation management system 1. FIG. 19 shows a processing procedure of a display process of the management screen. The administrator inputs information about the instruction for displaying management screen using the input unit of administrator terminal 7 (step S41).

Processor 74 of administrator terminal 7 transmits information about the instruction for displaying management screen to server 5 in response to the input of the display instruction in step S41, and data reception unit 59 of server 5 receives the information (step S42).

Display control unit 61 of server 5 reads latest vehicle data 55 from storage device 52 for each of the in-vehicle apparatus IDs based on the instruction information (step S43).

Display control unit 61 of server 5 generates management screen information for displaying management screen 140 as shown in FIG. 14 based on read vehicle data 55 (step S44). It is assumed that the correspondence information between the in-vehicle apparatus ID and the in-vehicle apparatus name, the vehicle name, and the occupant name is stored in storage device 52 in advance. Display control unit 61 generates information of the in-vehicle apparatus name, the vehicle name, and the occupant name of management screen 140 by referring to the correspondence information. The last operation date and time of management screen 140 is derived from the time stamp of vehicle data 55.

Display control unit 61 of server 5 transmits the generated management screen information to administrator terminal 7, and processor 74 of administrator terminal 7 receives the information (step S45).

Display control unit 61 of server 5 displays management screen 140 as shown in FIG. 14 on display unit 73 based on the received management screen information (step S46).

According to an embodiment of the present disclosure, a version is determined according to a type of vehicle data collected by in-vehicle apparatus 3, and the vehicle data is converted into format data of a version corresponding to the type of the vehicle data and then transmitted from in-vehicle apparatus 3 to server 5. Thus, server 5 can use the version as a clue to restore the format data to vehicle data using a conversion method appropriate for each version. Thus, server 5 can efficiently collect vehicle data from a plurality of vehicles 2 having different numbers and types of sensors mounted thereon.

Further, server 5 can display vehicle data collected from a plurality of vehicles 2 having different numbers and types of sensors mounted thereon on administrator terminal 7.

Further, server 5 can display the vehicle data of the type desired by the administrator from the vehicle data collected by server 5 on administrator terminal 7.

Further, server 5 can display notification data collected from a plurality of vehicles 2 on administrator terminal 7 in association with the positions of vehicles 2 on the map. For example, when the occupant notifies the rest area, the rest area is displayed on the map. This makes it possible to notify the rest area to another administrator or occupant who has viewed the display. In this way, notification data can be supplied among administrators or a plurality of occupants.

Further, server 5 also causes administrator terminal 7 to display data related to at least one of the amount of carbon dioxide in vehicle 2, the amount of odor in vehicle 2, and the breath alcohol concentration of the occupant of vehicle 2 in association with the position of vehicle 2 on the map. This enables administrators to identify vehicle 2 and the position of vehicle 2 in which the abnormality of the amount of carbon dioxide in vehicle 2, the amount of odor in vehicle 2, or the breath alcohol concentration of the occupant occurs.

Further, server 5 registers conversion rule information 54 for restoring the vehicle data from the format data in server 5, and registers conversion rule information for generating the format data from the vehicle data in in-vehicle apparatus 3. Thus, even when a new sensor is added to vehicle 2 and vehicle data collected by in-vehicle apparatus 3 is added, in-vehicle apparatus 3 and server 5 can perform data conversion between vehicle data and format data according to the new conversion rule information.

### Modification 1

In the above embodiment, smartphone 4 transmits the notification data to server 5. However, in-vehicle apparatus 3 may transmit the notification data to server 5.

For example, a physical switch corresponding to the notification data is provided at a position where the crew can operate, such as the dashboard of vehicle 2. The physical switch is connected to interface unit 32 of in-vehicle apparatus 3. When the crew pushes any physical switch, data collection unit 37 of in-vehicle apparatus 3 collects notification data corresponding to the physical switch, and data transmission unit 39 transmits the collected notification data to server 5.

### Modification 2

In the above embodiment, server 5 transmits the screen information to administrator terminal 7, and administrator terminal 7 displays the screen information. In contrast, server 5 transmit the screen information to smartphone 4 and may cause smartphone 4 to display the screen information. For example, vehicle data screen 120 shown in FIG. 12 can be displayed on smartphone 4. Thus, the passenger of vehicle 2 can be notified of the contents of the notification data.

### Appendix

Some or all of the constituent elements constituting each of the above devices may be constituted by one or more semiconductor devices such as system LSIs.

The computer program may be recorded in a computer-readable non-transitory recording medium, for example, an HDD, a CD-ROM, a semiconductor memory, or the like, and distributed. Further, the computer program may be distributed by being transmitted via an electric communication line, a wireless or wired communication line, a network represented by the Internet, data broadcasting, or the like. Furthermore, each of the above-described devices may be configured by a plurality of computers or a plurality of processors.

Further, some or all of the functions of the respective devices may be provided by cloud computing. That is, some or all of the functions of the respective devices may be realized by a cloud server.

Furthermore, at least a part of the embodiments and modifications may be combined as desired.

The embodiments disclosed herein are to be considered in all respects as illustrative and not restrictive. The scope of the present invention is defined by the appended claims rather than the foregoing description, and is intended to include all modifications within the scope and meaning equivalent to the appended claims.

### REFERENCE SIGNS LIST

1 operation management system (vehicle data collection system)
2, 2A, 2B vehicle
3, 3A, 3B in-vehicle apparatus
4, 4A, 4B smartphone
5 server
7 administrator terminal
8 network
11 sensor group
12 in-vehicle control device
13 GPS receiver
14 clock
31, 51, 71 communication unit
32 interface unit
33, 52, 75 storage device
34, 53, 76 computer program
35 conversion rule information
36, 58, 74 processor
37 data collection unit
38 data conversion unit
39 data transmission unit
54 conversion rule information
55 vehicle data
56 notification data
57 display item information
59 data reception unit
60 data restoration unit
61 display control unit
62 display item information acquisition unit
63 vehicle data selection unit
64 conversion rule information registration unit
72 input unit
73 display unit
100,110,120 vehicle data screen
101 OK button
111, 111A, 111B, 111C, 113 vehicle icon
112, 112A, 112B, 112C beer mug icon
114 gas station icon
115 battery icon
116 warning icon
117,131 notification icon
130 settings screen
132 notification data content
140 management screen

1. A vehicle data collection system comprising:
an in-vehicle apparatus configured to be mounted on a vehicle; and
a server configured to collect data from the in-vehicle apparatus, wherein
the in-vehicle apparatus includes:
a data collection circuitry configured to collect vehicle data, the vehicle data being data related to the vehicle;
a data conversion circuitry configured to convert the collected vehicle data into format data of a version corresponding to a type of the vehicle data and write the version to the format data; and
a data transmission circuitry configured to transmit the format data with the version written thereto to the server, and
the server includes:
a data reception circuitry configured to receive the format data; and
a data restoration circuitry configured to restore the vehicle data from the format data, based on the version indicated in the format data.

2. The vehicle data collection system according to claim 1, wherein
the server further includes
a display control circuitry configured to display the vehicle data restored by the data restoration circuitry.

3. The vehicle data collection system according to claim 2, wherein
the server further includes:
a display item information acquisition circuitry configured to acquire display item information indicating a type of the vehicle data to be displayed; and
a vehicle data selection circuitry configured to select the vehicle data of the type indicated by the display item information from among pieces of the vehicle data having been restored, and
the display control circuitry is configured to display the vehicle data selected by the vehicle data selection circuitry.

4. The vehicle data collection system according to claim 2, wherein
the data collection circuitry is configured to collect a position of the vehicle as the vehicle data,
the data reception circuitry is configured to further receive notification data notified by an occupant of the vehicle, and
the display control circuitry is configured to further display the notification data received by the data reception circuitry in association with a position of the vehicle on a map, based on the vehicle data.

5. The vehicle data collection system according to claim 2, wherein
the data collection circuitry is configured to collect, as the vehicle data, data related to at least one of an amount of carbon dioxide in the vehicle, an amount of odor in the vehicle, and a breath alcohol concentration of an occupant of the vehicle, and a position of the vehicle, and
the display control circuitry is configured to display, based on the vehicle data, data restored by the data restoration circuitry and related to at least one of the amount of carbon dioxide in the vehicle, the amount of odor in the vehicle, and a breath alcohol amount of the occupant of the vehicle in association with a position of the vehicle on a map.

6. The vehicle data collection system according to claim 1, further comprising
a conversion rule information registration circuitry configured to register conversion rule information in the in-vehicle apparatus and the server, the conversion rule information indicating the version and a conversion method corresponding to the version, wherein
the conversion method includes a method of conversion between the vehicle data and the format data.

7. An in-vehicle apparatus comprising:
a data collection circuitry configured to collect vehicle data, the vehicle data being data related to a vehicle;
a data conversion circuitry configured to convert the collected vehicle data into format data of a version corresponding to a type of the vehicle data and write the version to the format data; and
a data transmission circuitry configured to transmit the format data with the version written thereto to a server.

8. A server comprising:
a data reception circuitry configured to receive format data obtained by converting vehicle data in accordance with a version corresponding to a type of the vehicle data, the vehicle data being data related to a vehicle, the format data having the version written thereto; and
a data restoration circuitry configured to restore the vehicle data from the format data, based on the version indicated in the format data.

9. A non-transitory computer-readable storage medium storing a computer program for causing a computer to function as:
a data collection circuitry configured to collect vehicle data, the vehicle data being data related to a vehicle;
a data conversion circuitry configured to convert the collected vehicle data into format data of a version corresponding to a type of the vehicle data and write the version to the format data; and
a data transmission circuitry configured to transmit the format data with the version written thereto to a server.

10. A non-transitory computer-readable storage medium storing a computer program for causing a computer to function as:
a data reception circuitry configured to receive format data obtained by converting vehicle data in accordance with a version corresponding to a type of the vehicle data, the vehicle data being data related to a vehicle, the format data having the version written thereto; and
a data restoration circuitry configured to restore the vehicle data from the format data, based on the version indicated in the format data.

11. A vehicle data collection method comprising:
by an in-vehicle apparatus mounted on a vehicle, collecting vehicle data, the vehicle data being data related to the vehicle;
by the in-vehicle apparatus, converting the collected vehicle data into format data of a version corresponding to a type of the vehicle data and writing the version to the format data;
by the in-vehicle apparatus, transmitting the format data with the version written thereto to a server;
by the server, receiving the format data; and
by the server, restoring the vehicle data from the format data, based on the version indicated in the format data.

12. The vehicle data collection system according to claim 3, wherein
the data collection circuitry is configured to collect a position of the vehicle as the vehicle data,
the data reception circuitry is configured to further receive notification data notified by an occupant of the vehicle, and
the display control circuitry is configured to further display the notification data received by the data reception circuitry in association with a position of the vehicle on a map, based on the vehicle data.

13. The vehicle data collection system according to claim 3, wherein
the data collection circuitry is configured to collect, as the vehicle data, data related to at least one of an amount of carbon dioxide in the vehicle, an amount of odor in the vehicle, and a breath alcohol concentration of an occupant of the vehicle, and a position of the vehicle, and
the display control circuitry is configured to display, based on the vehicle data, data restored by the data restoration circuitry and related to at least one of the amount of carbon dioxide in the vehicle, the amount of odor in the vehicle, and a breath alcohol amount of the occupant of the vehicle in association with a position of the vehicle on a map.

14. The vehicle data collection system according to claim 4, wherein
the data collection circuitry is configured to collect, as the vehicle data, data related to at least one of an amount of carbon dioxide in the vehicle, an amount of odor in the vehicle, and a breath alcohol concentration of an occupant of the vehicle, and a position of the vehicle, and
the display control circuitry is configured to display, based on the vehicle data, data restored by the data restoration circuitry and related to at least one of the amount of carbon dioxide in the vehicle, the amount of odor in the vehicle, and a breath alcohol amount of the occupant of the vehicle in association with a position of the vehicle on a map.

15. The vehicle data collection system according to claim 2, further comprising
a conversion rule information registration circuitry configured to register conversion rule information in the in-vehicle apparatus and the server, the conversion rule information indicating the version and a conversion method corresponding to the version, wherein
the conversion method includes a method of conversion between the vehicle data and the format data.

16. The vehicle data collection system according to claim 3, further comprising
a conversion rule information registration circuitry configured to register conversion rule information in the in-vehicle apparatus and the server, the conversion rule information indicating the version and a conversion method corresponding to the version, wherein
the conversion method includes a method of conversion between the vehicle data and the format data.

17. The vehicle data collection system according to claim 4, further comprising
a conversion rule information registration circuitry configured to register conversion rule information in the in-vehicle apparatus and the server, the conversion rule information indicating the version and a conversion method corresponding to the version, wherein
the conversion method includes a method of conversion between the vehicle data and the format data.

18. The vehicle data collection system according to claim 5, further comprising
a conversion rule information registration circuitry configured to register conversion rule information in the in-vehicle apparatus and the server, the conversion rule information indicating the version and a conversion method corresponding to the version, wherein
the conversion method includes a method of conversion between the vehicle data and the format data.
